(19) United States
(12) Patent Application Publication
(10) Pub. No.: US 2026/0296536 A1
(43) Pub. Date: Oct. 1, 2026

(54) CONTROLLER FOR FOUR-WHEEL STEERING VEHICLE, METHOD FOR CONTROLLING FOUR-WHEEL STEERING VEHICLE, AND PROGRAM FOR CONTROLLING FOUR-WHEEL STEERING VEHICLE

(71) Applicants: J-QuAD DYNAMICS INC., Tokyo (JP); DENSO CORPORATION, Kariya-city (JP); AISIN CORPORATION, Kariya-shi (JP); ADVICS CO., LTD., Kariya-shi (JP); JTEKT CORPORATION, Kariya-shi (JP)

(72) Inventors: Tomoya INAYOSHI, Tokyo (JP); Takuto KOZAKI, Tokyo (JP)

(73) Assignees: J-QuAD DYNAMICS INC., Tokyo (JP); DENSO CORPORATION, Kariya-city (JP); AISIN CORPORATION, Kariya-shi (JP); ADVICS CO., LTD., Kariya-shi (JP); JTEKT CORPORATION, Kariya-shi (JP)

(21) Appl. No.: 19/576,019

(22) Filed: Mar. 24, 2026

(30) Foreign Application Priority Data
Mar. 28, 2025 (JP) 2025-056374

(51) Int. Cl. B62D 6/00

(52) U.S. Cl. CPC B62D 6/002

(57) ABSTRACT

A controller for a four-wheel steering vehicle sets a command front wheel steering angle, which is a commanded value of a front wheel steering angle, and a command rear wheel steering angle, which is a commanded value of a rear wheel steering angle. The controller acquires the front wheel steering angle and the rear wheel steering angle. The controller calculates an ideal yaw rate based on the command front wheel steering angle and the command rear wheel steering angle as input variables. The controller calculates an estimated yaw rate based on the front wheel steering angle and the rear wheel steering angle as input variables. The controller calculates a deviation of the estimated yaw rate from the ideal yaw rate. The controller corrects at least one of the command front wheel steering angle and the command rear wheel steering angle based on the deviation as an input variable.

### CROSS-REFERENCE TO RELATED APPLICATIONS

This application is based upon and claims the benefit of priority from Japanese Patent Application No. 2025-056374, filed on Mar. 28, 2025 the entire contents of which are incorporated herein by reference.

### BACKGROUND

### 1. Field

The present disclosure relates to a controller for a four-wheel steering vehicle, a method for controlling a four-wheel steering vehicle, and a program for controlling a four-wheel steering vehicle.

### 2. Description of Related Art

JP2008-74192A describes a controller for a four-wheel steering vehicle. When the vehicle is in an emergency avoidance state, the controller controls a rear-wheel steering amount in phase with the front wheels so as to stabilize lateral motion of the vehicle body.

An actuator for steering the front wheels and an actuator for steering the rear wheels differ in dead time and the degree of response delay. Therefore, when the timing of steering one of the front wheel and the rear wheel delays relative to the timing of steering the other of the front wheel and the rear wheel, the four-wheel steering vehicle may deviate from the target travel trajectory.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect of the present disclosure provides a controller for a four-wheel steering vehicle. The controller is configured to execute a command steering angle setting process, an actual steering angle acquisition process, an ideal yaw rate calculation process, an estimated yaw rate calculation process, a deviation calculation process, and a correction process. The command steering angle setting process sets a command front wheel steering angle and a command rear wheel steering angle. The command front wheel steering angle is a commanded value of a front wheel steering angle. The command rear wheel steering angle is a commanded value of a rear wheel steering angle. The actual steering angle acquisition process acquires the front wheel steering angle and the rear wheel steering angle. The ideal yaw rate calculation process calculates an ideal yaw rate based on the command front wheel steering angle and the command rear wheel steering angle as input variables. The estimated yaw rate calculation process calculates an estimated yaw rate based on the front wheel steering angle and the rear wheel steering angle as input variables. The deviation calculation process calculates a deviation of the estimated yaw rate from the ideal yaw rate. The correction process corrects at least one of the command front wheel steering angle and the command rear wheel steering angle based on the deviation as an input variable.

One aspect of the present disclosure provides a method for controlling a four-wheel steering vehicle. The method includes executing a command steering angle setting process, executing an actual steering angle acquisition process, executing an ideal yaw rate calculation process, executing an estimated yaw rate calculation process, executing a deviation calculation process, and executing a correction process. The command steering angle setting process sets a command front wheel steering angle and a command rear wheel steering angle. The command front wheel steering angle is a commanded value of a front wheel steering angle. The command rear wheel steering angle is a commanded value of a rear wheel steering angle. The actual steering angle acquisition process acquires the front wheel steering angle and the rear wheel steering angle. The ideal yaw rate calculation process calculates an ideal yaw rate based on the command front wheel steering angle and the command rear wheel steering angle as input variables. The estimated yaw rate calculation process calculates an estimated yaw rate based on the front wheel steering angle and the rear wheel steering angle as input variables. The deviation calculation process calculates a deviation of the estimated yaw rate from the ideal yaw rate. The correction process corrects at least one of the command front wheel steering angle and the command rear wheel steering angle based on the deviation as an input variable.

One aspect of the present disclosure provides a program for controlling a four-wheel steering vehicle. The program includes a command that causes a computer to execute a command steering angle setting process, an actual steering angle acquisition process, an ideal yaw rate calculation process, an estimated yaw rate calculation process, a deviation calculation process, and a correction process. The command steering angle setting process sets a command front wheel steering angle and a command rear wheel steering angle. The command front wheel steering angle is a commanded value of a front wheel steering angle. The command rear wheel steering angle is a commanded value of a rear wheel steering angle. The actual steering angle acquisition process acquires the front wheel steering angle and the rear wheel steering angle. The ideal yaw rate calculation process calculates an ideal yaw rate based on the command front wheel steering angle and the command rear wheel steering angle as input variables. The estimated yaw rate calculation process calculates an estimated yaw rate based on the front wheel steering angle and the rear wheel steering angle as input variables. The deviation calculation process calculates a deviation of the estimated yaw rate from the ideal yaw rate. The correction process corrects at least one of the command front wheel steering angle and the command rear wheel steering angle based on the deviation as an input variable.

Other features and aspects will be apparent from the following detailed description, the drawings, and the claims.

### BRIEF DESCRIPTION OF THE DRAWINGS

FIG. 1 is a diagram showing a control system for a four-wheel steering vehicle according to one embodiment.

FIG. 2 is a block diagram showing a process executed by a controller shown in FIG. 1.

FIG. 3 is a flowchart showing a process of lateral motion control shown in FIG. 2.

FIG. 4 is a block diagram showing part of the process shown in FIG. 3 in detail.

FIG. 5 is an exemplary diagram showing a situation to which the process shown in FIG. 3 is applied.

FIG. 6 includes time charts showing the effect of the embodiment.

FIG. 7 is a chart showing behavior of detection values of a yaw rate.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment will now be described with reference to the drawings.

### Configuration of Control System for Four-Wheel Steering Vehicle

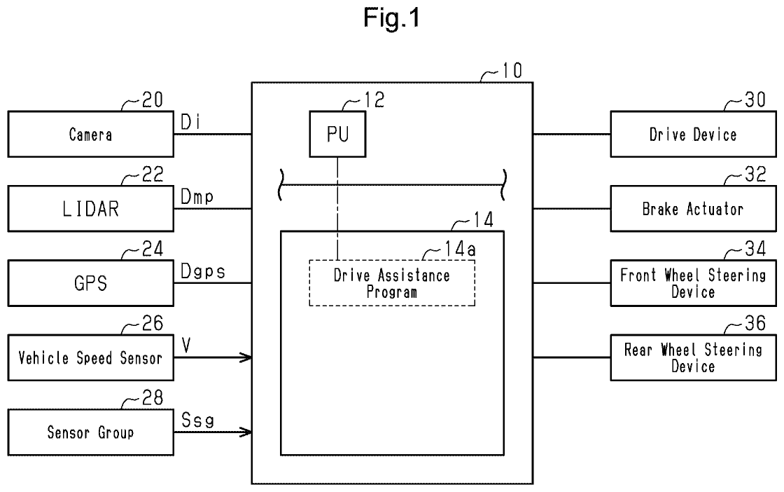

As shown in FIG. 1, a controller 10 for a four-wheel steering vehicle includes a processing unit 12 (PU) and a storage device 14. The PU 12 is, for example, a processing unit that executes software processing such as a central processing unit (CPU) or a graphics processing unit (GPU). The storage device 14 may be a storage medium such as electrically-rewritable non-volatile memory or a disk medium. The PU 12 executes programs stored in the storage device 14 to perform various processes. Particularly, the storage device 14 stores a drive assistance program 14a. The PU 12 executes the drive assistance program 14a to assist in the driving of the four-wheel steering vehicle.

The controller 10 refers to image data Di indicating external images captured by a camera 20. The controller 10 also refers to ranging point data Dmp that is output from a light detection and ranging device 22 (LIDAR). The ranging point data Dmp includes a signal generated based on reception of reflected light when laser light is emitted. The ranging point data Dmp is linked to information related to the distance to an object reflecting laser light in the emission direction of the laser light. The controller 10 refers to position data Dgps that is output from a global positioning system 24 (GPS). The controller 10 refers to a vehicle speed V of the four-wheel steering vehicle detected by a vehicle speed sensor 26. The controller 10 refers to a detection value Ssg detected by a sensor group 28. For the sake of brevity, the detection value Ssg collectively represents detection values of multiple sensors. The detection value Ssg includes a detection value of the tire angle of a front wheel (hereafter, referred to as front wheel steering angle) and a detection value of the tire angle of a rear wheel (hereafter, referred to as rear wheel steering angle), a yaw rate, and steering torque. The steering torque is torque that is input by a driver into the steering wheel. The detection value of the tire angle may be calculated based on an accumulated value of detected rotation angles of a motor configured to steer wheels.

A drive device 30 includes at least one of an internal combustion engine and a rotating electric machine as a propulsion force generation device for a vehicle.

A brake actuator 32 is configured to apply a braking force to the front wheels and the rear wheels of the four-wheel steering vehicle.

A front wheel steering device 34 includes an actuator that steers the front wheels of the four-wheel steering vehicle.

A rear wheel steering device 36 includes an actuator that steers the rear wheels of the four-wheel steering vehicle.

### Overview of Drive Assistance

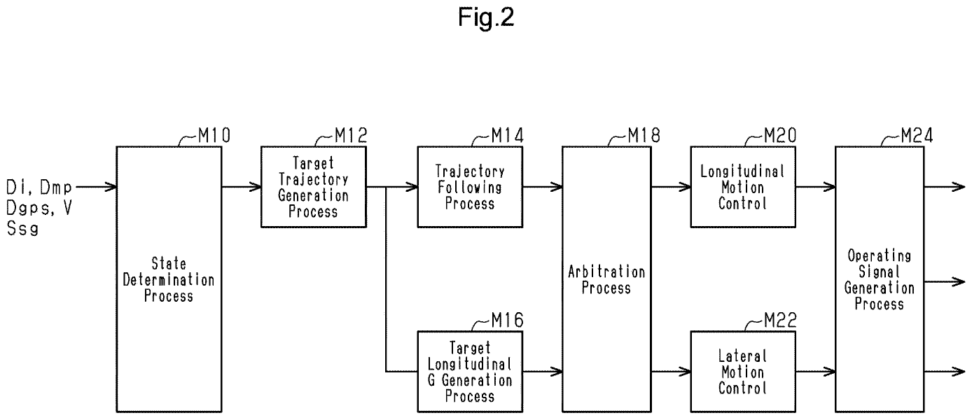

FIG. 2 shows the overview of processes related to the drive assistance. The processes shown in FIG. 2 are executed when the PU 12 executes the drive assistance program 14a.

A state determination process M10 determines the state of the four-wheel steering vehicle based on input signals, namely, the image data Di, the ranging point data Dmp, the position data Dgps, the vehicle speed V, and the detection value Ssg. The state determination process M10 includes a process of determining whether an object is present ahead of the four-wheel steering vehicle in the travel direction. The state determination process M10 includes a process of predicting, when an object is present ahead of the four-wheel steering vehicle in the travel direction, a risk of contact with the object. The state determination process M10 includes a process of determining, when it is predicted that there is a risk of contact with the object, the probability of avoiding such contact.

A target trajectory generation process M12 generates a target trajectory of the four-wheel steering vehicle in accordance with the state determined by the state determination process M10.

A trajectory following process M14 includes a process of setting a target value of a state amount causing the four-wheel steering vehicle to travel along the target trajectory. In an example, the target value includes a target vehicle body slip angle β0* and a target yaw rate γ0*.

A target longitudinal G generation process M16 sets a target value of acceleration in the longitudinal direction of the four-wheel steering vehicle.

An arbitration process M18 arbitrates between the output value of the trajectory following process M14 and the output value of the target longitudinal G generation process M16.

A longitudinal motion control M20 calculates an operation amount for controlling acceleration of the four-wheel steering vehicle in the longitudinal direction based on an output value of the arbitration process M18.

A lateral motion control M22 calculates an operation amount for controlling the tire angle of the front wheel and the tire angle of the rear wheel of the four-wheel steering vehicle based on the target vehicle body slip angle β* and the target yaw rate γ*, which are output from the arbitration process M18.

An operating signal generation process M24 outputs operating signals to the drive device 30, the brake actuator 32, the front wheel steering device 34, and the rear wheel steering device 36 based on the operation amounts as input variables.

### Detail of Lateral Motion Control M22

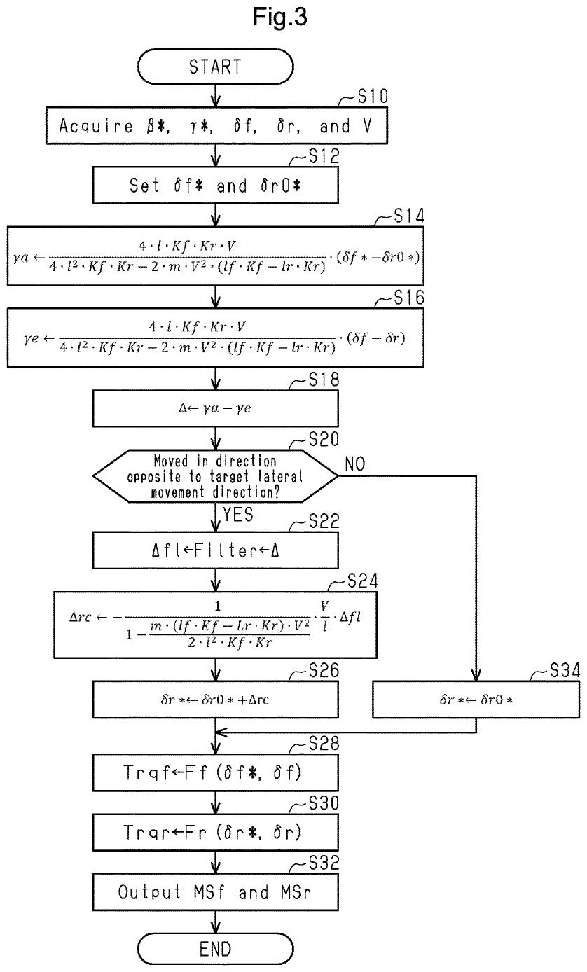

FIG. 3 shows the procedures of the lateral motion control M22 and an operating signal generation process M24, which is related to the lateral motion control M22. The process shown in FIG. 3 is implemented, for example, by the PU 12 repeatedly executing the drive assistance program 14a in a predetermined cycle. In the following description, the character ‘S’ affixed to a number represents a step number.

In the process shown in FIG. 3, the PU 12 first acquires a target vehicle body slip angle β*, a target yaw rate γ*, a front wheel steering angle δf, a rear wheel steering angle δr, and a vehicle speed V (S10). The front wheel steering angle δf and the rear wheel steering angle δr are detected by the sensor group 28. The PU 12 sets a command front wheel steering angle δf* and a command rear wheel steering angle δr0* based on the target vehicle body slip angle β* and the target yaw rate γ* as input variables (S12).

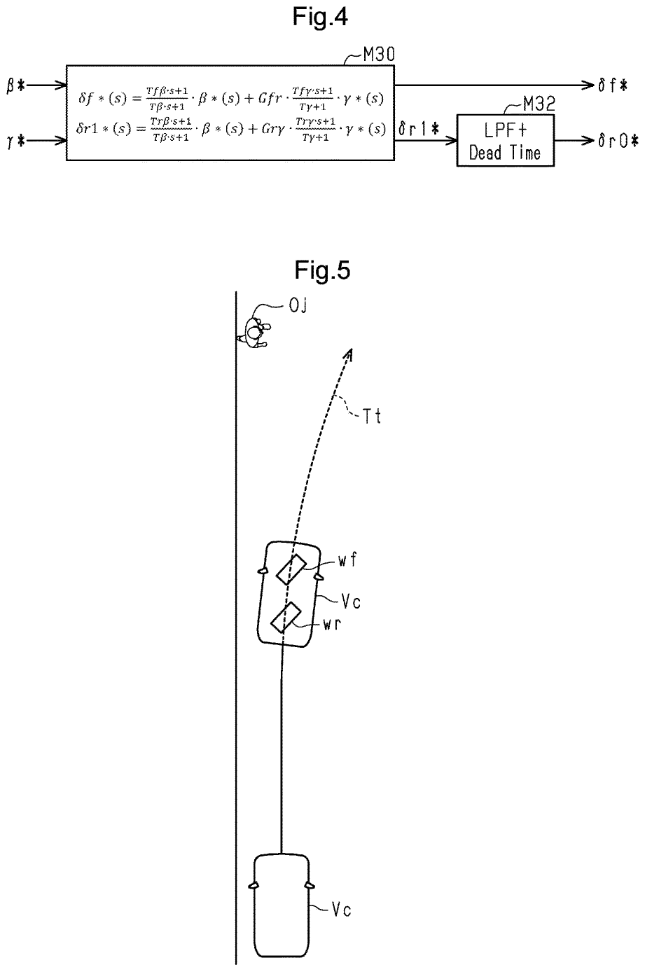

FIG. 4 shows the detail of step S12.

A command steering angle setting process M30 sets the command front wheel steering angle δf* and a command rear wheel steering angle base value δr1* based on the target vehicle body slip angle β* and the target yaw rate γ* as input variables. The command front wheel steering angle δf* is set based on a transfer function expressed by Equation (c1). The command rear wheel steering angle base value δr1* is set based on a transfer function expressed by Equation (c2).

$$( c1 )$$

$$δ {f}^{*} ( s ) = \{ ( Tf β \cdot s + 1 ) / ( T β \cdot s + 1 ) \} \cdot {β}^{*} ( s ) + \{ Gf γ \cdot ( Tf γ \cdot s + 1 ) / ( T γ \cdot s + 1 ) \} \cdot {γ}^{*} ( s )$$

$$( c2 )$$

$$δ r {1}^{*} ( s ) = \{ ( Tr β \cdot s + 1 ) / ( T β \cdot s + 1 ) \} \cdot {β}^{*} ( s ) + \{ Gr γ \cdot ( Tr γ \cdot s + 1 ) / ( T γ \cdot s + 1 ) \} \cdot {γ}^{*} ( s )$$

In Equations (c1) and (c2), Tfβ, Trβ, Tfγ, Trγ are first-order lead time constants. Also, Tβ and Tγ are first-order lag time constants. In Equations (c1) and (c2), Gfγ is a yaw rate gain of a front wheel. Also, Grγ is a yaw rate gain of a rear wheel.

Practically, step S12 uses variables in a discrete system. Therefore, the transfer functions of Equations (c1) and (c2) are converted to the discrete system to determine the command front wheel steering angle δf* and the command rear wheel steering angle base value δr1*. The denominator in the transfer functions is a first-order lag filter. The numerator in the transfer functions represents a response determined from a plant model.

A delay process M32 performs a low pass filtering process and a dead time applying process on the command rear wheel steering angle base value δr1*, which serves as an input variable, to set the command rear wheel steering angle δr0*. The delay process M32 mitigates the difference in response characteristics between the front wheel steering device 34 and the rear wheel steering device 36 of the four-wheel steering vehicle in the present embodiment. More specifically, in the four-wheel steering vehicle of the present embodiment, the response of the rear wheel steering device 36 is sufficiently high as compared with the response of the front wheel steering device 34. Taking into consideration a response delay of the front wheel steering device 34, the delay process M32 is provided so that the timing of reflecting a change in the command front wheel steering angle δf* on the front wheel steering angle δf is synchronized with the timing of reflecting a change in the command rear wheel steering angle δr0* on the rear wheel steering angle δr.

Referring back to FIG. 3, the PU 12 calculates an ideal yaw rate γa based on the command front wheel steering angle δf* and the command rear wheel steering angle δr0* as input variables using Equation (c3) (S14).

$$( c3 )$$

$$γ a = 4 \cdot l \cdot Kf \cdot Kr \cdot V \cdot ( δ {f}^{*} - δ r {0}^{*} ) / \{ 4 \cdot l \hat{} 2 \cdot Kf \cdot Kr - 2 \cdot m \cdot V \hat{} 2 \cdot ( lf \cdot Kf - lr \cdot Kr ) \}$$

Equation (c3) is derived using a two-wheel model of a four-wheel steering vehicle in which a first-order time derivative of the yaw rate γ and a first-order time derivative of the vehicle body slip angle β are expressed by the yaw rate γ, the vehicle body slip angle β, the front wheel steering angle δf, the rear wheel steering angle δr, and the vehicle speed V. Specifically, Equation (c3) is derived using the two-wheel model when the first-order time derivative of the yaw rate γ and the first-order time derivative of the vehicle body slip angle β are set to zero. Equation (c3) includes a wheelbase l, a front-wheel cornering stiffnesses Kf, a rear-wheel cornering stiffnesses Kr, a gravity-center-to-front-wheel distance lf, and a gravity-center-to-rear-wheel distance lr.

The PU 12 calculates an estimated yaw rate γe based on the front wheel steering angle δf and the rear wheel steering angle δr as input variables (S16). Step S16 uses an equation obtained by replacing the ideal yaw rate γa, the command front wheel steering angle δf*, and the command rear wheel steering angle δr0* with the estimated yaw rate γe, the front wheel steering angle δf, and the rear wheel steering angle δr, respectively, in Equation (c3).

The PU 12 substitutes a value obtained by subtracting the estimated yaw rate γe from the ideal yaw rate γa into deviation Δ (S18).

The PU 12 determines whether the four-wheel steering vehicle moves in a direction opposite to a target lateral movement direction based on the deviation Δ as an input variable (S20). When it is determined that the four-wheel steering vehicle moves in the opposite direction (S20: YES), the PU 12 performs a filtering process on the deviation Δ to calculate deviation Δfl (S22). The filtering process uses a low-pass filter. The filtering process may be a first-order lag filter or a second-order lag filter.

The PU 12 calculates a correction amount Δrc of the command rear wheel steering angle δr0* based on the deviation Δfl as an input variable (S24). More specifically, the PU 12 substitutes a value obtained by multiplying deviation Δfl and a proportional gain shown in Expression (c4) into the correction amount Δrc.

$$[ - 1 / \{ 1 - m \cdot V \hat{} 2 \cdot ( lf \cdot Kf - lr \cdot Kr ) / 2 \cdot l \hat{} 2 \cdot Kf \cdot Kr \} ] \cdot ( V / l ) \qquad ( c4 )$$

Equation (c4) shows a gain of a steering angle with respect to the yaw rate during steady-state cornering in the two-wheel model of the four-wheel steering vehicle. The PU 12 calculates the proportional gain using Expression (c4) based on the vehicle speed V as an input variable.

The PU 12 substitutes a value obtained by adding the correction amount Δrc to the command rear wheel steering angle δr0* into a command rear wheel steering angle δr* (S26).

The PU 12 substitutes an operation amount of feedback control in which the front wheel steering angle δf is a control amount, and the command front wheel steering angle δf* is a target value of the control amount into a command front wheel torque Trqf (S28). The command front wheel torque Trqf is a commanded torque value for a motor included in the front wheel steering device 34.

The PU 12 substitutes an operation amount of feedback control in which the rear wheel steering angle δr is a control amount, and the command rear wheel steering angle δr* is a target value of the control amount into a command rear wheel torque Trqr (S30). The command rear wheel torque Trqr is a commanded torque value for a motor included in the rear wheel steering device 36.

The PU 12 outputs an operating signal MSf for a drive circuit of the motor in the front wheel steering device 34 and an operating signal MSr for a drive circuit of the motor in the rear wheel steering device 36 (S32).

When a negative determination is made in step S20, the PU 12 substitutes the command rear wheel steering angle δr0* into the command rear wheel steering angle δr* (S34). When completing step S34, the PU 12 proceeds to step S28.

When completing step S32, the PU 12 temporarily ends the process shown in FIG. 3. The command steering angle setting process corresponds to step S12. The actual steering angle acquisition process corresponds to step S10. The ideal yaw rate calculation process corresponds to step S14. The estimated yaw rate calculation process corresponds to step S16. The deviation calculation process corresponds to step S18. The correction process corresponds to steps S22 to S26. The vehicle speed acquisition process corresponds to step S10. The filtering process corresponds to step S22. The feedback process corresponds to steps S28 and S30. The determination process corresponds to step S20.

### Operation and Advantages of the Present Embodiment

FIG. 5 shows an example of drive assistance. In the example shown in FIG. 5, a person is present as an object Oj ahead of a four-wheel steering vehicle Vc in the travel direction. In this case, the PU 12 generates a target trajectory Tt in the travelable region to avoid the object Oj. In the example in FIG. 5, the target trajectory Tt turning the four-wheel steering vehicle Vc right is generated. The PU 12 controls the rear wheel Wr in phase with the front wheel Wf to turn the four-wheel steering vehicle Vc.

In the in-phase control, for example, when the response of the front wheel Wf delays, the yaw rate γ resulting from advancement of the steering of the rear wheel Wr may have a sign opposite to the target yaw rate γ*. Deviation of a behavior of the four-wheel steering vehicle from an intended behavior based on the command front wheel steering angle δf* and the command rear wheel steering angle δr0* is determined by a discrepancy between the difference of the front wheel steering angle δf from the command front wheel steering angle δf* and the difference of the rear wheel steering angle δr from the command rear wheel steering angle δr0*. However, it is difficult to directly process the two types of differences. In this regard, the PU 12 quantifies the discrepancy between the difference of the front wheel steering angle δf from the command front wheel steering angle δf* and the difference of the rear wheel steering angle δr from the command rear wheel steering angle δr0* based on the deviation Δ of the estimated yaw rate γe from the ideal yaw rate γa. The deviation Δ is an appropriate parameter indicating behavior of the four-wheel steering vehicle. The PU 12 corrects the command rear wheel steering angle δr0* with the correction amount Δrc corresponding to the deviation Δ.

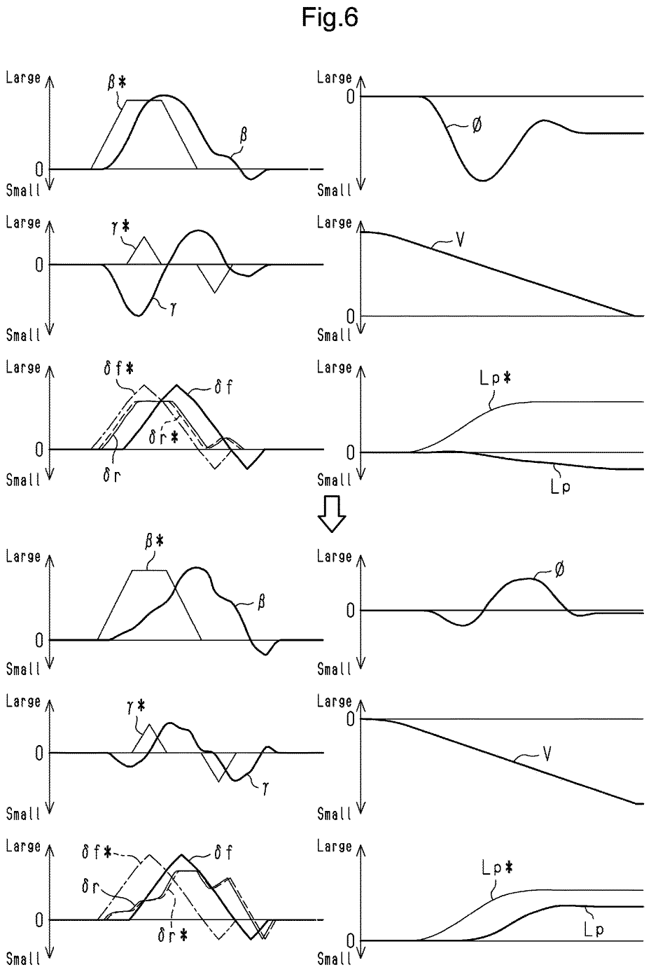

In FIG. 6, the upper section shows graphs from a state in which the command rear wheel steering angle δr0* is not corrected with the correction amount Δrc. In the upper section of FIG. 6, a lateral position Lp of the four-wheel steering vehicle deviates greatly from a target lateral position Lp* specified by the target trajectory.

In FIG. 6, the lower section shows graphs from a state in which the command rear wheel steering angle δr0* is corrected with the correction amount Δrc. As shown in the lower section of FIG. 6, in the present embodiment, the lateral position Lp of the four-wheel steering vehicle is shifted toward the target lateral position Lp*. In addition, as compared with the upper section of FIG. 6, a yaw angle φ does not largely change to the opposite side.

As described above, even when the response of the front wheel Wf is delayed more than expected in the in-phase control, the four-wheel steering vehicle Vc travels away from the object Oj.

The present embodiment described above further obtains the following operation and advantages.
(1) The PU 12 calculates a proportional gain for calculating the correction amount Δrc from the deviation Δfl based on the vehicle speed V as an input variable. Thus, the proportional gain is calculated more appropriately in accordance with the vehicle speed V.
(2) The proportional gain for calculating the correction amount Δrc from the deviation Δfl is calculated using an equation of a steady-state cornering expressed by Equation (c4). This reduces the workload for adapting the proportional gain.
(3) The PU 12 multiplies the deviation Δfl by the proportional gain instead of multiplying the deviation Δ by the proportional gain. This reduces the effect of noise on the correction amount Δrc.
(4) The PU 12 calculates the ideal yaw rate γa and the estimated yaw rate γe using a steady-state model equation obtained by setting the time derivative of the vehicle body slip angle and the time derivative of the yaw rate to zero in a two-wheel model of the four-wheel steering vehicle. Thus, the deviation Δ is a steady-state solution of the deviation of the estimated yaw rate γe from the ideal yaw rate γa. More specifically, the deviation Δ is a steady deviation that is generated when the command front wheel steering angle δf*, the front wheel steering angle δf, the command rear wheel steering angle δr0*, and the rear wheel steering angle δr remain in the current state. Therefore, the deviation Δ allows for quick and proper recognition of how the current state deviates from the intended behavior of the vehicle based on the command front wheel steering angle δf* and the command rear wheel steering angle δr0*. Such deviation from the intended behavior of the vehicle based on the command front wheel steering angle δf* and the command rear wheel steering angle δr0* is quickly reduced using the deviation Δ.
(5) Only when an affirmative determination is made in step S20, the PU 12 corrects the command rear wheel steering angle δr0* with the correction amount Δrc. This minimizes a situation in which the correction amount Δrc acts as a disturbance factor of the feedback process shown in steps S28 and S30.

In particular, in the situation shown in FIG. 5, when a negative determination is made in step S20, if the correction is performed, the correction may interfere with the feedback process while the four-wheel steering vehicle Vc is traveling away from the object Oj. That is, while the four-wheel steering vehicle Vc is traveling in a direction away from the object Oj, the correction may limit the traveling in the away direction.
(6) The deviation Δ is set to the difference between the ideal yaw rate γa and the estimated yaw rate γe instead of being set to the difference between the ideal yaw rate γa and a detected yaw rate γ. The yaw rate γ may be detected by a yaw rate sensor in the sensor group 28. When a large sprung variation occurs due to, for example, quick deceleration or quick turning of the four-wheel steering vehicle, the variation causes the yaw rate γ to deviate from the actual yaw rate.

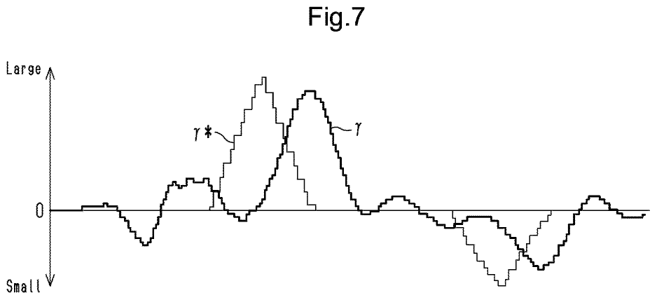

FIG. 7 shows an example in which the yaw rate γ is unstable. When the detected yaw rate γ has an error and is used to calculate the deviation Δ, the accuracy of determination made in step S20 performed based on the deviation Δ is low, and the correction amount Δrc does not become an appropriate value.

In this regard, the deviation Δ is set to the difference between the ideal yaw rate γa and the estimated yaw rate γe. Thus, the deviation Δ correctly quantifies the state of the four-wheel steering vehicle.
(7) As the upper section of FIG. 6 shows changes in the front wheel steering angle δf, the command front wheel steering angle δf*, the rear wheel steering angle δr, and the command rear wheel steering angle δr*, in the present embodiment, the response of the front wheel steering device 34 is delayed relative to the response of the rear wheel steering device 36. In this regard, the PU 12 corrects the command rear wheel steering angle δr0* with the correction amount Δrc. As a result, the effect of the correction using the correction amount Δrc is quickly reflected.
(8) As the upper section of FIG. 6 show changes in the front wheel steering angle δf, the command front wheel steering angle δf*, the rear wheel steering angle δr, and the command rear wheel steering angle δr*, in the present embodiment, the response of the front wheel steering device 34 is delayed relative to the response of the rear wheel steering device 36. In this regard, the PU 12 executes the delay process M32 to generate the command rear wheel steering angle δr0* by delaying the phase of the command rear wheel steering angle base value δr1*. This compensates for the response of the front wheel steering device 34 being delayed relative to the response of the rear wheel steering device 36. In other words, the relationship between the front wheel steering angle δf and the rear wheel steering angle δr may be matched with the relationship between the command front wheel steering angle δf* and the command rear wheel steering angle base value δr1*.

### Other Embodiments

The above embodiment may be modified as described below. The embodiments and the following modified examples can be combined as long as the combined modified examples remain technically consistent with each other.

### Command Steering Angle Setting Process

The command steering angle setting process does not necessarily have to be the process shown in FIG. 4. For example, the filtering process may be omitted from the command steering angle setting process M30. For example, when the response of the actuator for steering the front wheel is higher than the response of the actuator for steering the rear wheel, the delay process M32 may be performed on the command value of the front wheel steering angle δf.

The input variables of the command steering angle setting process do not necessarily have to be the target yaw rate γ* and the target vehicle body slip angle β*. The input variables of the command steering angle setting process may be, for example, the vehicle speed V and steering torque, which is torque that is input by the driver into the steering wheel.

### Ideal Yaw Rate Calculation Process and Estimated Yaw Rate Calculation Process

The ideal yaw rate calculation process does not necessarily have to calculate the ideal yaw rate γa using the steady-state model in which the first-order time derivative of the yaw rate γ and the first-order time derivative of the vehicle body slip angle β are set to zero. For example, the yaw rate γ may be calculated accounting for the first-order time derivative. The same applies to the estimated yaw rate calculation process.

### Proportional Element

The gain of the proportional element does not necessarily have to be calculated by the above-described equation determined by an equation of steady-state cornering. For example, the gain of the proportional element may be a value obtained by map calculation using map data generated using the above-described equation. In the map data, the vehicle speed V is an input variable, and the gain is an output variable.

The map data refers to a data set of discrete values of an input variable and values of an output variable corresponding to each value of the input variable. In map calculation, when the value of an input variable matches one of the values of input variables in the map data, the value of the corresponding output variable in the map data may be used as a calculation result. In map calculation, when the value of the input variable does not match any of the values of the input variables in the map data, a value obtained by interpolation of values of the output variables in the map data may be used as a calculation result. Alternatively, in map calculation, when the value of the input variable does not match any of the values of the input variables in the map data, the value of the output variable in the map data corresponding to the value of the closest one of the input variables included in the map data may be used as a calculation result.

### Filtering Process

The filtering process does not necessarily have to use the deviation Δ as an input variable. For example, the filtering process may use a value obtained by multiplying the deviation Δ by the proportional gain as an input variable.

The filtering process does not necessarily have to be provided for noise removal. For example, when the ideal yaw rate calculation process and the estimated yaw rate calculation process use a first-order lead model, it is preferred that a first- or higher-order filter be set. As described in the “Ideal Yaw Rate Calculation Process and Estimated Yaw Rate Calculation Process” section, the first-order lead model corresponds to a model that differs from setting the first-order time derivative of the yaw rate γ and the first-order time derivative of the vehicle body slip angle β to zero.

### Correction Amount

The correction amount Δrc does not necessarily have to be an output value of the proportional element. The correction amount Δrc may be, for example, a sum of an output value of a proportional element and an output value of a derivative element when the deviation Δfl is an input variable. The correction amount Δrc may be, for example, a sum of an output value of a proportional element and an output value of an integral element when the deviation Δfl is an input variable. The correction amount Δrc may be, for example, a sum of an output value of a proportional element, an output value of an integral element, and an output value of a derivative element when the deviation Δfl is an input variable.

The subject of correction with the correction amount does not necessarily have to be the command rear wheel steering angle δr0*. For example, when the response of the actuator for steering the front wheel is higher than the response of the actuator for steering the rear wheel, the subject of correction may be the command front wheel steering angle.

The subject of correction with the correction amount does not necessarily have to be one of the command rear wheel steering angle and the command front wheel steering angle. The subject of correction with the correction amount may be, for example, both the command rear wheel steering angle and the command front wheel steering angle.

The correction amount does not necessarily have to be calculated by the deviation Δ of the estimated yaw rate γe from the ideal yaw rate γa only. For example, the calculation may account for a deviation of the estimated vehicle body slip angle βe from the ideal vehicle body slip angle βa. The estimated vehicle body slip angle βe and the ideal vehicle body slip angle βa may be calculated using, for example, an equation obtained in the process of deriving the model equation used to calculate the ideal yaw rate γa and the estimated yaw rate γe.

### Correction Process

The command rear wheel steering angle δr0* does not necessarily have to be corrected on condition that an affirmative determination is made in step S20. For example, steps S20 and S34 may be omitted from the process shown in FIG. 3,

For the correction process, the logic that executes in-phase control for avoiding an object does not necessarily have to be included in the control device.

### Determination Process

The input variable of the determination process may be the deviation Δfl instead of the deviation Δ.

### Controller

The controller 10 does not necessarily have to be accommodated in a single housing. For example, the controller may be configured such that multiple control units disposed at different positions of the four-wheel steering vehicle are configured to communicate with each other.

The controller does not necessarily have to be implemented by a PU that executes processes. The controller may include, for example, a dedicated hardware circuit, such as an application-specific integrated circuit (ASIC), executing at least a part of the processes executed in the above embodiment. More specifically, the controller may include any one of the processing circuitries described below in (a) to (c). (a) Processing circuitry including a processor that executes all of the above processes in accordance with programs, and a program storing device such as a storage device that stores the programs. (b) Processing circuitry including a processor that executes some of the above processes in accordance with programs, a program storing device, and a dedicated hardware circuit that executes the remaining processes. (c) Processing circuitry including a dedicated hardware circuit that executes all of the processes. Multiple software execution devices each including a processor and a program storage device may be provided. Multiple dedicated hardware circuits may be provided.

### Subject That Executes Control

The subject executing the process shown in FIG. 2 does not have to be the controller mounted on the four-wheel steering vehicle. In an example, the state determination process M10, a target trajectory generation process M12, and step S20 may be executed by a portable terminal carried by the driver.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller for a four-wheel steering vehicle, the controller being configured to execute:
a command steering angle setting process;
an actual steering angle acquisition process;
an ideal yaw rate calculation process;
an estimated yaw rate calculation process;
a deviation calculation process; and
a correction process, wherein
the command steering angle setting process sets a command front wheel steering angle and a command rear wheel steering angle, the command front wheel steering angle being a commanded value of a front wheel steering angle, the command rear wheel steering angle being a commanded value of a rear wheel steering angle,
the actual steering angle acquisition process acquires the front wheel steering angle and the rear wheel steering angle,
the ideal yaw rate calculation process calculates an ideal yaw rate based on the command front wheel steering angle and the command rear wheel steering angle as input variables,
the estimated yaw rate calculation process calculates an estimated yaw rate based on the front wheel steering angle and the rear wheel steering angle as input variables,
the deviation calculation process calculates a deviation of the estimated yaw rate from the ideal yaw rate, and
the correction process corrects at least one of the command front wheel steering angle and the command rear wheel steering angle based on the deviation as an input variable.

2. The controller according to claim 1, wherein the correction process includes a process that calculates a correction amount in accordance with an output value of a proportional element based on the deviation as an input variable.

3. The controller according to claim 2, the controller being configured to execute:
a vehicle speed acquisition process, wherein
the vehicle speed acquisition process acquires a vehicle speed, and
the correction process includes a process that variably sets a gain of the proportional element in accordance with the vehicle speed as an input variable.

4. The controller according to claim 2, wherein the gain of the proportional element is set using an expression of a steady-state cornering in a model of the four-wheel steering vehicle.

5. The controller according to claim 2, wherein the process that calculates a correction amount in the correction process includes a filtering process in addition to the process using the proportional element.

6. The controller according to claim 1, wherein
the ideal yaw rate calculation process and the estimated yaw rate calculation process include a process that calculates an output value using a model equation in which the front wheel steering angle and the rear wheel steering angle are input variables and a yaw rate is an output variable, and
the model equation is obtained by using an equation in which a first-order time derivative of the yaw rate and a first-order time derivative of the vehicle body slip angle are expressed by the yaw rate, the vehicle body slip angle, the front wheel steering angle, and the rear wheel steering angle such that each of the time derivatives is set to zero.

7. The controller according to claim 1, the controller being configured to execute:
a feedback process; and
a determination process, wherein
the feedback process includes a process that operates the front wheel steering device by feedback control in which the front wheel steering angle is a control amount and the command front wheel steering angle is a target value of the control amount, and a process that operates the rear wheel steering device by feedback control in which the rear wheel steering angle is a control amount and the command rear wheel steering angle is a target value of the control amount,
the determination process determines whether the four-wheel steering vehicle moves in a direction opposite to a target traveling direction, based on the deviation as an input variable, and
the correction process corrects at least one of the command front wheel steering angle and the command rear wheel steering angle when it is determined that the four-wheel steering vehicle moves in the opposite direction.

8. The controller according to claim 1, wherein the correction process corrects the command rear wheel steering angle.

9. The controller according to claim 8, wherein the command steering angle setting process includes a process that sets the command front wheel steering angle based on an input variable, a process that sets a command rear wheel steering angle base value based on the input variable, and a process that sets the command rear wheel steering angle by delaying a phase of the command rear wheel steering angle base value.

10. A method for controlling a four-wheel steering vehicle, the method comprising:
executing a command steering angle setting process;
executing an actual steering angle acquisition process;
executing an ideal yaw rate calculation process;
executing an estimated yaw rate calculation process;
executing a deviation calculation process; and
executing a correction process, wherein
the command steering angle setting process sets a command front wheel steering angle and a command rear wheel steering angle, the command front wheel steering angle being a commanded value of a front wheel steering angle, the command rear wheel steering angle being a commanded value of a rear wheel steering angle,
the actual steering angle acquisition process acquires the front wheel steering angle and the rear wheel steering angle,
the ideal yaw rate calculation process calculates an ideal yaw rate based on the command front wheel steering angle and the command rear wheel steering angle as input variables,
the estimated yaw rate calculation process calculates an estimated yaw rate based on the front wheel steering angle and the rear wheel steering angle as input variables,
the deviation calculation process calculates a deviation of the estimated yaw rate from the ideal yaw rate, and
the correction process corrects at least one of the command front wheel steering angle and the command rear wheel steering angle based on the deviation as an input variable.

11. A program for controlling a four-wheel steering vehicle, the program comprising:
a command that causes a computer to execute a command steering angle setting process, an actual steering angle acquisition process, an ideal yaw rate calculation process, an estimated yaw rate calculation process, a deviation calculation process, and a correction process, wherein
the command steering angle setting process sets a command front wheel steering angle and a command rear wheel steering angle, the command front wheel steering angle being a commanded value of a front wheel steering angle, the command rear wheel steering angle being a commanded value of a rear wheel steering angle,
the actual steering angle acquisition process acquires the front wheel steering angle and the rear wheel steering angle,
the ideal yaw rate calculation process calculates an ideal yaw rate based on the command front wheel steering angle and the command rear wheel steering angle as input variables,
the estimated yaw rate calculation process calculates an estimated yaw rate based on the front wheel steering angle and the rear wheel steering angle as input variables,
the deviation calculation process calculates a deviation of the estimated yaw rate from the ideal yaw rate, and
the correction process corrects at least one of the command front wheel steering angle and the command rear wheel steering angle based on the deviation as an input variable.
